(19) United States
(12) Patent Application Publication
(10) Pub. No.: US 2007/0198730 A1
(43) Pub. Date: Aug. 23, 2007

(54) Embedded system with a bus and arbitration method for same

(75) Inventors: Wen-Chung Tsai, ZhongHe City (TW); Jung-Tsan Hsu, Xindian City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: VIA Technologies Inc.

(21) Appl. No.: 11/357,572

(22) Filed: Feb. 17, 2006

(51) Int. Cl. G06F 15/16

(52) U.S. Cl. 709/230

(57) ABSTRACT

The present invention relates to an embedded system and method, and in particular relates to an embedded system with a bus and an arbitration method. An arbitration method is applied in an embedded system that comprises a plurality of devices, a bus and an arbiter. Each device comprises a buffer and a time-to-death value. The arbiter chooses one device to access data through the bus according to the plurality of TTD values. The arbitration method comprises: sending a plurality of request signals to the arbiter; choosing one device to access data through the bus according to the plurality of TTD values, wherein the chosen device with a minimum TTD value is chosen; increasing the TTD value of the chosen device when the chosen device is accessing data through the bus; choosing another device to access data through the bus when the TTD value of another device becomes minimum.

### BACKGROUND OF THE INVENTION

1. Field of the Invention

The present invention relates to an embedded system and method, and in particular relates to an embedded system with a bus and an arbitration method for same.

2. Description of the Related Art

Please refer to FIG. 1. FIG. 1 shows a block diagram illustrating a related art shared-bus system 100. The shared-bus system comprises an arbiter 110, a plurality of bus-master devices (e.g. CPU) 122,124,126,128, a bus-slave device (e.g. memory) 130, and a bus 140. The plurality of bus-master devices can send data to the bus-slave device 130 through the bus 140. If more than two bus-master devices want to access data through the bus 140, however, only one bus-master device is allowed to access data through the bus 140 at the same time. When a bus-master device wants to access data, a request signal is first sent to the arbiter 110 to obtain the authority to utilize bus 140. The arbiter 110 chooses one from a plurality of bus-master devices to access data according to the plurality of corresponding request signals. A detailed description of the arbiter 110 is provided in the following.

Please refer to FIG. 2. FIG. 2 shows a schematic diagram of the arbiter 110 processing a plurality of request signals. For example, the request signal REQ_1 is sent from the bus-master device 122 when the bus-master device 122 wants to access data; the request signal REQ_2 is sent from the bus-master device 124 when the bus-master device 124 wants to access data; the request signal REQ_3 is sent from the bus-master device 126 when the bus-master device 126 wants to access data; the request signal REQ_4 is sent from the bus-master device 128 when the bus-master device 128 wants to access data. If the arbiter 110 chooses the bus-master device 122 as the current device to access data, the grant signal GNT_1 is activated. Similarly, the grant signals GNT_2, GNT_3, and GNT_4 will be respectively activated if a corresponding bus-master device is chosen as the current device to access data. A detailed description of arbitration of the arbiter 110 is provided in the following.

Please refer to FIG. 3A and FIG. 3B at the same time. FIG. 3A shows a timing diagram of plurality of request and grant signals under a first related arbitration. FIG. 3B shows the priority of each bus-master device. At time T₀, since only the request signal REQ_1 is sent (pulled high), the arbiter 110 activates the grant signal GNT_1 to authorize the corresponding bus-master device 122 to utilize the bus to access data. At times T₀₁, T₀₂, T₀₃, the bus-master devices 128, 126, 124 respectively send the request signals REQ_4, REQ_3, REQ_2. At time T₁, the bus-master device 122 de-asserts the request signal REQ_1 and the arbiter 110 then de-asserts the corresponding grant signal GNT_1. The arbiter 110 actives the grant signal REQ_2 to authorize the corresponding bus-master device 124 to utilize the bus to access data. Please refer to FIG. 3B. It shows that the bus-master device 122, 124, 126, 128 always has the highest, second highest, third highest, and lowest arbitration priorities, respectively. Thus, the arbiter 110 activates the grant signal GNT_2 at time T₁. At time T₁₁, the bus-master device 122 with the highest priority sends the request signal REQ_1 again but the authority to utilize the bus is still on the bus-master device 124 since it has not yet de-asserted the request signal REQ_2. At time T₂, the request signal REQ_2 is de-asserted and the arbiter 110 activates another grant signal. This time the grant signal GNT_1 is activated since it has the highest priority. Similarly, the grant signals GNT_3 and GNT_4 are activated at time T₃ and T₄, respectively. Another arbitration of the arbiter 110 is provided in the following.

Please refer to FIG. 4A and FIG. 4B at the same time. FIG. 4A shows a timing diagram of plurality of request and grant signals under a second related arbitration. FIG. 4B shows the priority of each bus-master device. The priority of each bus-master device changes with time. The bus-master device 122 has the highest priority in the beginning. The bus-master device 124 then has the highest while the bus-master device 122 has the lowest priority. At time T₀, since only the request signal REQ_1 is sent (pulled high), the arbiter 110 activates the grant signal GNT_1 to authorize the corresponding bus-master device 122 to utilize the bus to access data. At times T₀₁, T₀₂, T₀₃, the bus-master devices 128, 126, 124 respectively send the request signals REQ_4, REQ_3, REQ_2. At time T₁, the bus-master device 122 de-asserts the request signal REQ_1 and the arbiter 110 then de-asserts the corresponding grant signal GNT_1. The arbiter 110 activates the grant signal REQ_2 to authorize the corresponding bus-master device 124 to utilize the bus to access data. Please refer to FIG. 3B. At time T₁, the priority sequence changes and the bus-master device 124 has the highest priority. Therefore, the grant signal REQ_2 is activated. At time T₁₁, the bus-master device 122 with the lowest priority sends the request signal REQ_1 again while the authority to utilize the bus is still on the bus-master device 124 since it has not de-asserted the request signal REQ_2 yet. At time T₂, the request signal REQ_2 is de-asserted and the arbiter 110 activates another grant signal. This time the grant signal GNT_3 is activated since it has the highest priority. Similarly, the grant signals GNT_4 is activated at time T₃.

The first and second related arbitrations, however, may not be good enough in some situations. In the first related arbitration (FIG. 3), the bus-master device 122, 124, 126, 128 always has the highest, second highest, third highest, and lowest arbitration priorities, respectively. In other words, the priority of each bus-master device will never change. Hence the bus-master device of lower arbitration priority will never obtain the bus grant in the competition with other bus-master device of higher arbitration priority. In the second related arbitration (FIG. 4), the priority sequence changes with time, and each bus-master device has chance to obtain higher priority. Compared with the first related arbitration, it seems to be fairer in the second related arbitration. It, however, is not efficient to match the real requirement of each bus-master device.

### BRIEF SUMMARY OF THE INVENTION

A detailed description is given in the following embodiments with reference to the accompanying drawings.

An arbitration method is applied in an embedded system communicating with other systems through a medium. The embedded system comprises a plurality of devices, a bus and an arbiter. Each device comprises a buffer and a time-to-death value. The arbiter chooses one device to access data through the bus according to the plurality of TTD values. The arbitration method comprises: sending a plurality of request signals to the arbiter; choosing one device to access data through the bus according to the plurality of TTD values, wherein the chosen device with a minimum TTD value is chosen; increasing the TTD value of the chosen device when the chosen device is accessing data through the bus; choosing another device to access data through the bus when the TTD value of another device becomes minimum. Each TTD value is utilized to record a current state of its corresponding buffer.

The embedded system comprises: means for sending a plurality of request signals to the arbiter; means for choosing one device to access data through the bus according to the plurality of TTD values, wherein the chosen device with a minimum TTD value is chosen; means for increasing the TTD value of the-chosen device, when the chosen, device is accessing data through the bus; means for choosing another device to access data through the bus when the TTD value of another device becomes minimum.

### BRIEF DESCRIPTION OF THE DRAWINGS

The present invention can be more fully understood by reading the subsequent detailed description and examples with references made to the accompanying drawings, wherein:

FIG. 1 shows a block diagram illustrating a related art shared-bus system;

FIG. 2 shows a schematic diagram of the arbiter processing a plurality of request signals;

FIG. 3A shows a timing diagram of plurality of request and grant signals under a first related arbitration;

FIG. 3B shows the priority of each bus-master device;

FIG. 4A shows a timing diagram of a plurality of request and grant signals under a second related arbitration;

FIG. 4B shows the priority of each bus-master device;

FIG. 5 shows a block diagram illustrating an embedded system according to an embodiment of the invention;

FIG. 6 shows a block diagram of the bus-master device in FIG. 5;

FIG. 7 shows a schematic diagram of the arbiter processing a plurality of request signals with the TTD values;

FIG. 8 shows the relationship between the transmitted buffer size (e.g. TX FIFO) and the TTD value;

FIG. 9 shows a timing diagram of the plurality of TX FIFOs in different advices in FIG. 5;

FIG. 10 shows the variation relationship between the TTD value and the TX FIFO;

FIG. 11 is a flowchart of the TX FIFO operation method according to an embodiment of the invention;

FIG. 12 is a flowchart of the TTD variation of TX operation method according to an embodiment of the invention;

FIG. 13 shows the relationship between the received buffer size and the TTD value;

FIG. 14 shows the variation relationship between the TTD value and the RX FIFO;

FIG. 15 is a flowchart of the RX FIFO operation method according to an embodiment of the invention;

FIG. 16 is a flowchart of the TTD variation of RX operation method according to an embodiment of the invention.

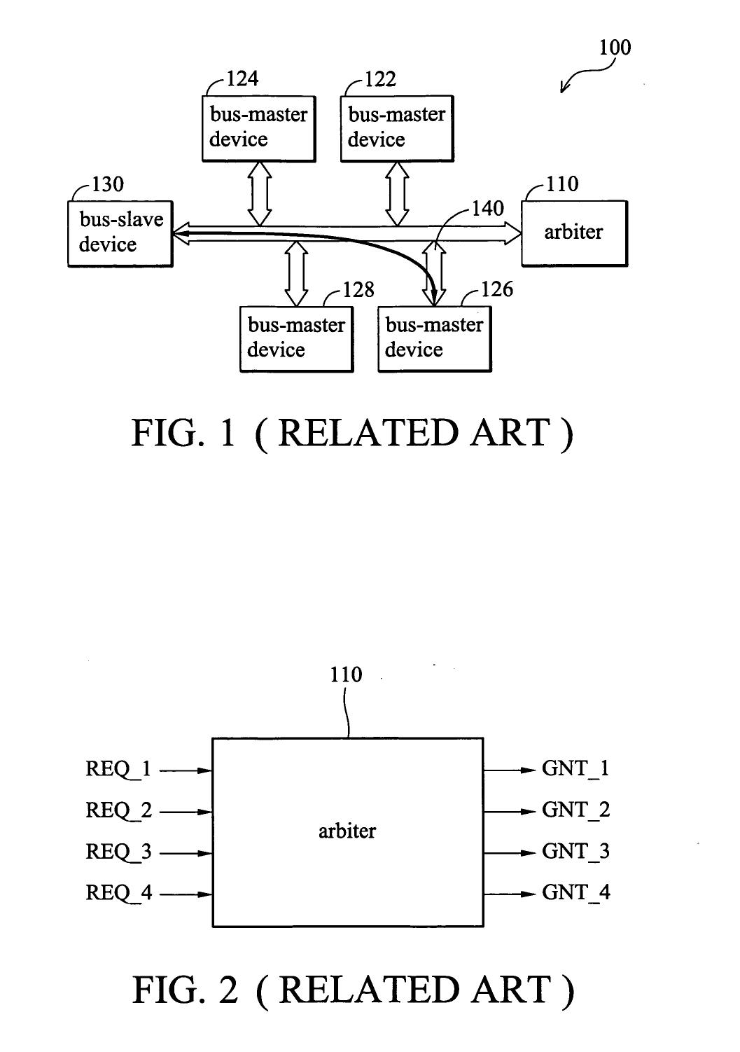

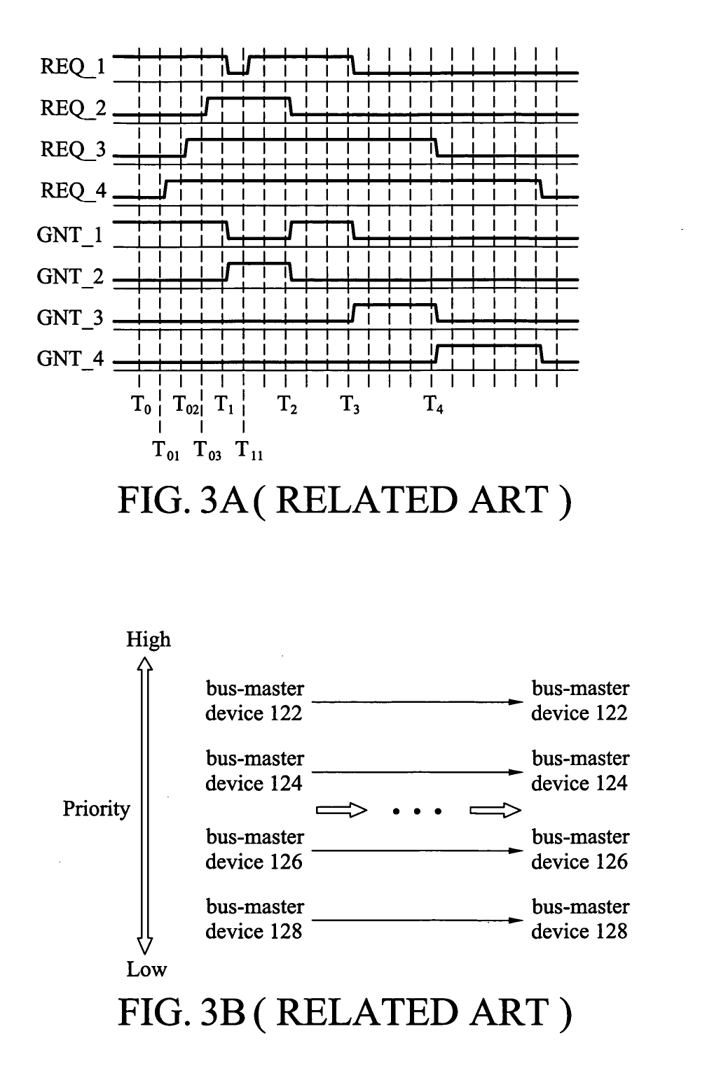

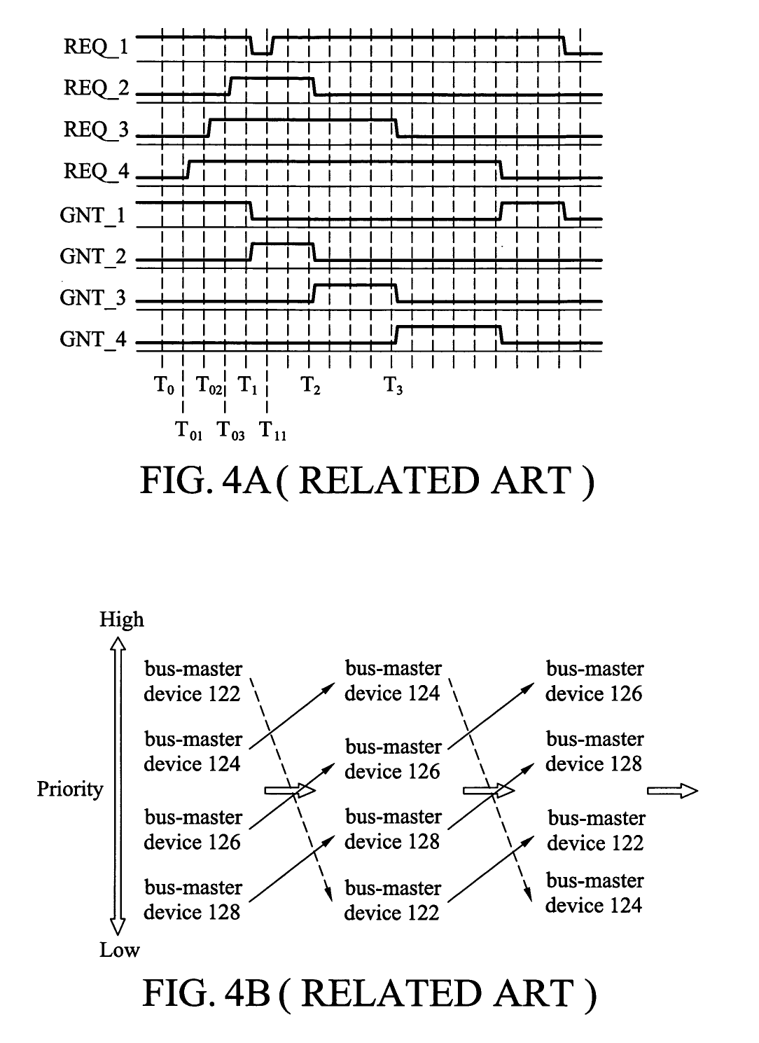

### DETAILED DESCRIPTION OF INVENTION

The following description is of the best-contemplated mode of carrying out the invention. This description is made for-the purpose of illustrating the general principles of the invention and should not be taken in a limiting sense. The scope of the invention is best determined by reference to the appended claims.

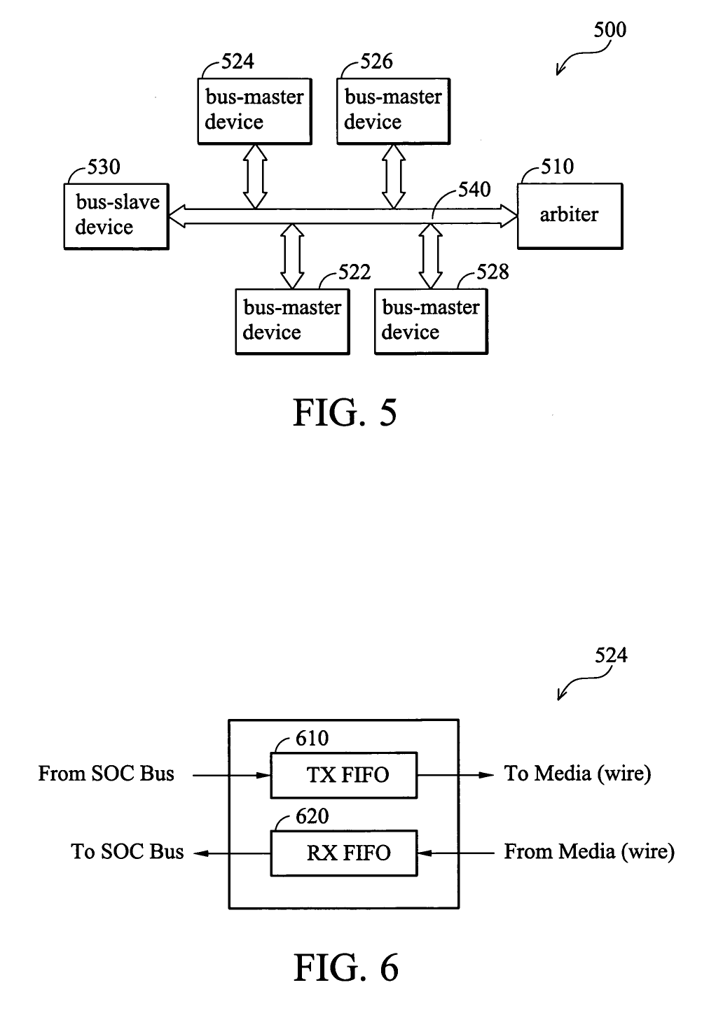

Please refer to FIG. 5. FIG. 5 shows a block diagram illustrating an embedded system 500 according to an embodiment of the invention. The embedded system comprises an arbiter 510, a plurality of bus-master devices (e.g. Ethernet MAC or CPU) 522, 524, 526 and 528, a bus-slave device (e.g. DDR SDRAM) 530, and a bus (e.g. AHB bus) 540. The plurality of bus-master devices. 522˜528 can send data to the bus-slave device 530 through the bus 440. If more than two devices (comprising processor and bus-master devices) want to access data through the bus 440, however, only one device is allowed to access data through the bus 440 at the same time. When any bus-master device wants to access data, a request signal with a time-to-death (TTD) value is sent to the arbiter 410 to obtain the authority to utilize the bus 440. The arbiter 410 chooses one from a plurality of bus-master devices to access data according to the plurality of corresponding request signals and TTD values. A detailed description of one bus-master device is provided in the following.

Please refer to FIG. 6. FIG. 6 shows a block diagram of the bus-master device in FIG. 5. The bus-master device is a kind of Ethernet MAC comprising a transmitted buffer 610 (e.g. TX FIFO) and a received buffer (e.g. RX FIFO) 620. The transmitted buffer 610 receives data from the bus 540 and transmits data to the medium (e.g. air). The received buffer 620 receives data from the medium (e.g. air) and transmits data to the bus 540. A detailed description of the arbiter 510 is provided in the following.

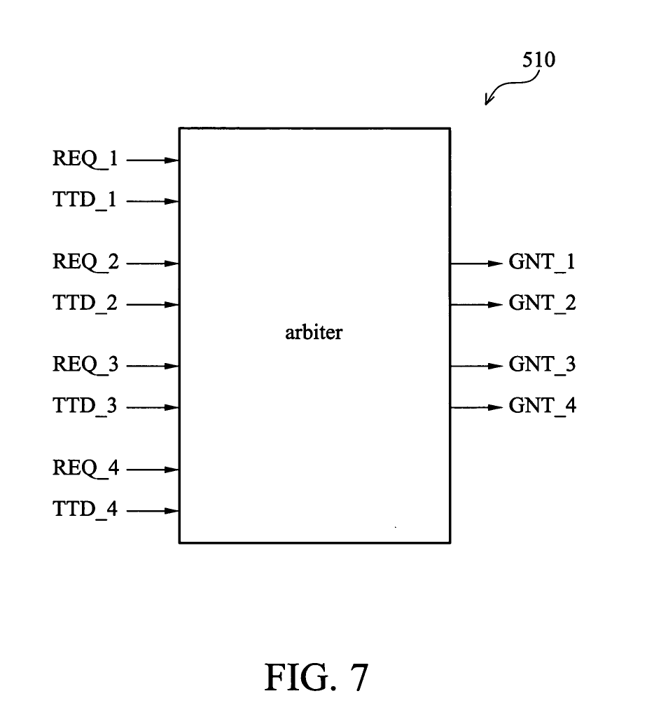

Please refer to FIG. 7. FIG. 7 shows a schematic diagram of the arbiter 510 processing a plurality of request signals with the TTD values. For example, the request signal REQ_1 and the TTD value TTD_1 are sent from the bus-master device 122 when the bus-master device 122 wants to access data; the request signal REQ_2 and the TTD value TTD_2 are sent from the bus-master device 124 when the bus-master device 124 wants to access data; the request signal REQ_3 and the TTD value TTD_3 are sent from the bus-master device 126 when the bus-master device 126 wants to access data; the request signal REQ_4 and the TTD value TTD_4 are sent from the bus-master device 128 when the bus-master device 128 wants to access data. If the arbiter 110 chooses the bus-master device 122 as the current device to access data, the grant signal GNT_1 is activated. Similarly, the grant signals GNT_2, GNT_3, and GNT_4 will be respectively activated if a corresponding bus-master device is chosen as the current device to access data. A detailed description of the relationship between the buffer size and the TTD value is provided in the following.

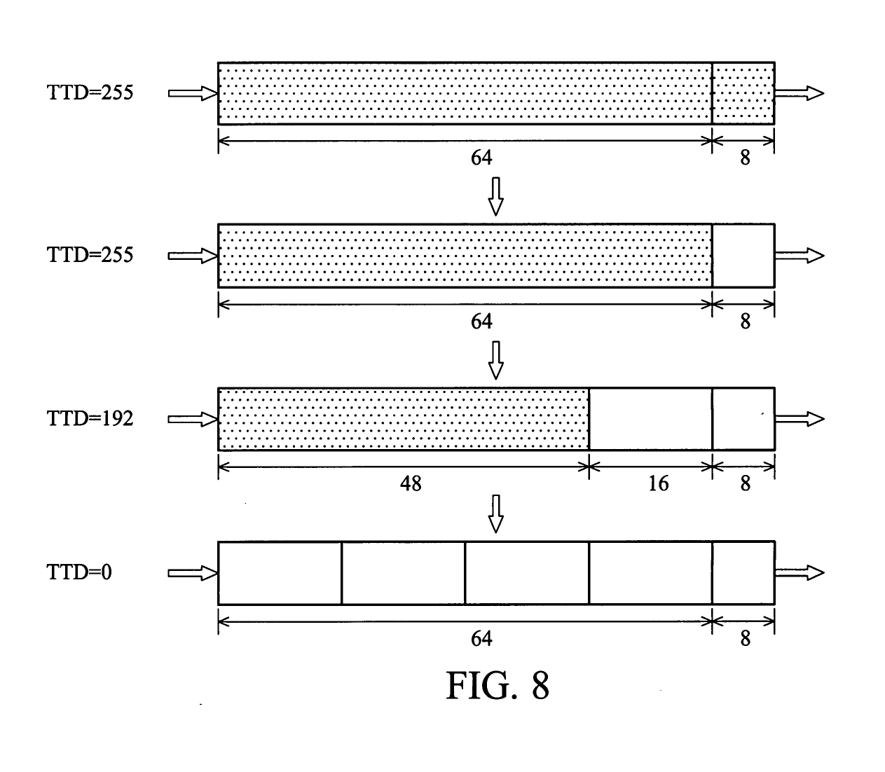

Please refer to FIG. 8. FIG. 8 shows the relationship between the transmitted buffer size (TX FIFO) and the TTD value. Assume the FIFO volume and the largest TTD value are 64 (bytes) and 255. Additionally, the length of a threshold segment is set to be 8 (bytes). In the first allocation, the threshold segment and the TX FIFO are full (72 bytes data inside). Please note that, after data in the threshold segment are transmitted to medium (the threshold segment is empty), the corresponding bus-master device will be allowed to send its request to re-fill data in the TX FIFO. When data in the TX FIFO is transmitted to medium, the TTD value is decreased relatively. When data is re-filled in the TX FIFO, the TTD value is increased relatively. In the second allocation, the threshold segment is empty while the TX FIFO is full (64 bytes data inside) and start to be transmitted to medium, then the TTD value reaches maximum (255). In the third allocation, the TX FIFO is decreased to be 48 (bytes), then the TTD value changes to be 192 (bytes). In the fourth allocation, the TX FIFO is decreased to be empty, then the TTD value changes to be zero. The TTD value is calculated according to the following formula:
TTD−TX=DR/DC

Wherein TTD−TX is the TTD value in the TX FIFO, DR is the data residual in the TX FIFO, and DC is the data consumption (output) rate to medium. The data consumption rate is a predetermined value. In FIG. 8, assume that the data consumption rate is equal to 0.25. It shows that the data residuals are 64 (bytes) in the second allocation, 48 (bytes) in the third allocation, and 0 (bytes) in the fourth allocation. Through the above formula, the TTD values in each allocation can be calculated to be, 255 (64/0.25) in the second allocation, 192 (48/0.25) in the third allocation, and 0 (0/0.25) in the fourth allocation. A detailed description of arbitration of the arbiter 510 is provided in the following.

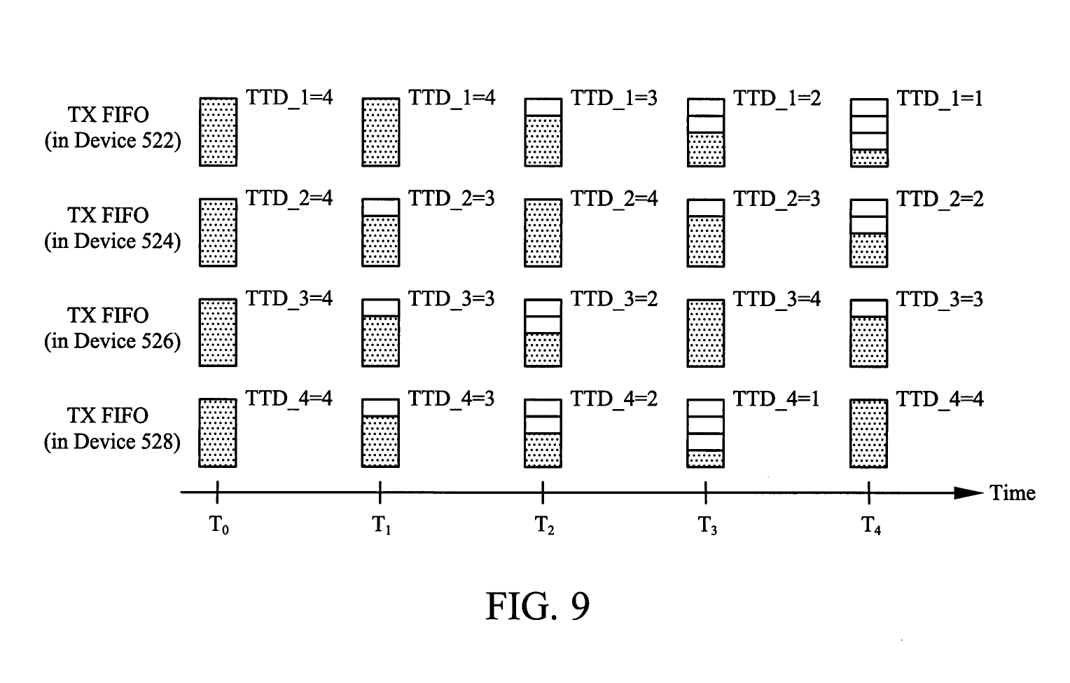

In FIG. 9, a TX FIFO is given as an example. FIG. 9 shows a timing diagram of the plurality of TX FIFOs in devices 522˜528 in FIG. 5. The TTD value is proportional to the current volume of the TX FIFO. If the TX FIFO is full, the TTD value will reach its maximum. If the TX FIFO is empty, the TTD value will then reach minimum. Additionally, the arbiter 510 selects one device with a minimum TTD value as a current device to utilize the bus 540. At time T₀, all of TX FIFOs are full and the corresponding TTD values are set to be a predetermined maximum value (e.g. 4). At time T₁, the device 522 is authorized to utilize the bus 540 to receive data and the other devices can still transmit data through the medium (e.g. air) to another system (not shown). After the other devices 524˜526 trasmit data in the TX FIFO through the medium, the volume of each FIFO is reduced and hence the corresponding TTD values TTD_2, TTD_3, TTD_4 are decreased (e.g. TTD equals to 3). At time T₂, assume that the device 524 is authorized to utilize the bus 540 to receive data and the other devices 522, 526, 528 can still transmit data through the medium to another system (not shown). After the device 524 receives data from the bus 540, the volume of its TX FIFO is increased and the corresponding TTD value TTD_2 is increased. At the same time, the other devices 522, 526, and 528 transmit data through the medium to another system and hence the corresponding TTD values TTD_1, TTD_3, TTD_4 are decreased. Similarly, at time T₃ (assume that the device 526 is authorized to utilize the bus 540), the TTD value TTD_3 is increased and the other TTD values TTD_1, TTD_2, TTD_4 are decreased; at time T₄ (assume that the device 528 is authorized to utilize the bus 540), the TTD value TTD_4 is increased and the other TTD values TTD_1, TTD_2, TTD_3 are decreased. A detailed description of the variation relationship between the TTD value and the TX FIFO is provided in the following.

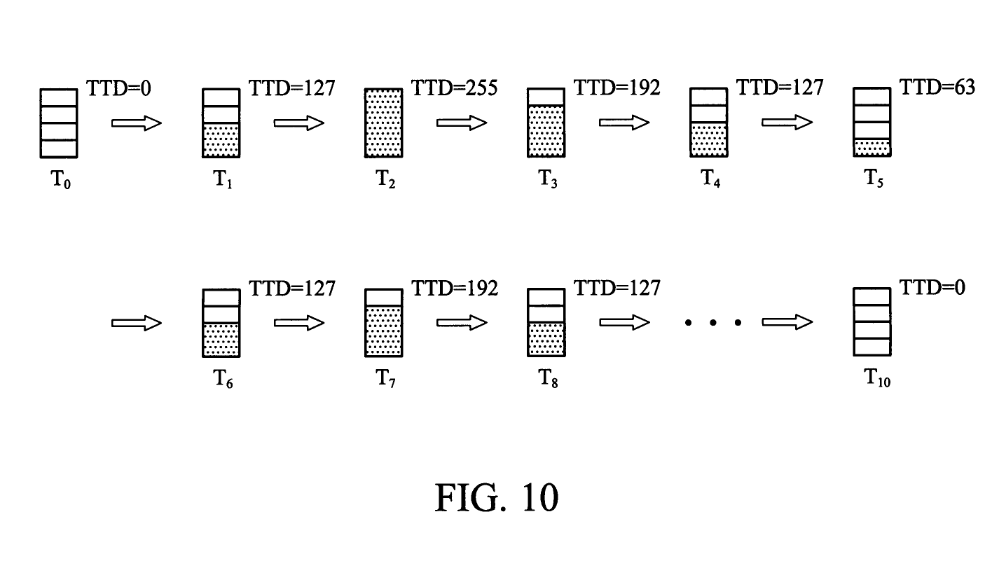

Please refer to FIG. 10. FIG. 10 shows the variation relationship between the TTD value and the TX FIFO. Assuming the maximum TTD value is 255. At time T₀, the TX FIFO is empty and hence the TTD value is equal to zero. At time T₁, data is received from the bus 540 to fill half of the TX FIFO and the TTD value is increased to reach half the maximum TTD value (127). At time T₃, the FIFO is full and starts to transmit data to the medium (e.g. air). The corresponding TTD reaches maximum (255) at this time. During the duration T₃˜T₅, the TX FIFO is not authorized to utilize the bus 540 and hence it can only transmit data to the medium. Additionally, it sends a request signal to request authorization to utilize the bus 540 again in duration T₃˜T₅. In duration T₆˜T₇, the FIFO again obtains the authorization to transmit partial data to the medium and other partial data can be received from the bus at the same time. Usually, the reception speed is faster than the transmittion speed and hence the TTD value is increased until the FIFO is full. At time T₈, the TX FIFO loses its authority again and only transmits data to the medium. Hence the TTD value decreases again. After a long time, the transmission task is finished at time T₉ and the TTD value returns to zero.

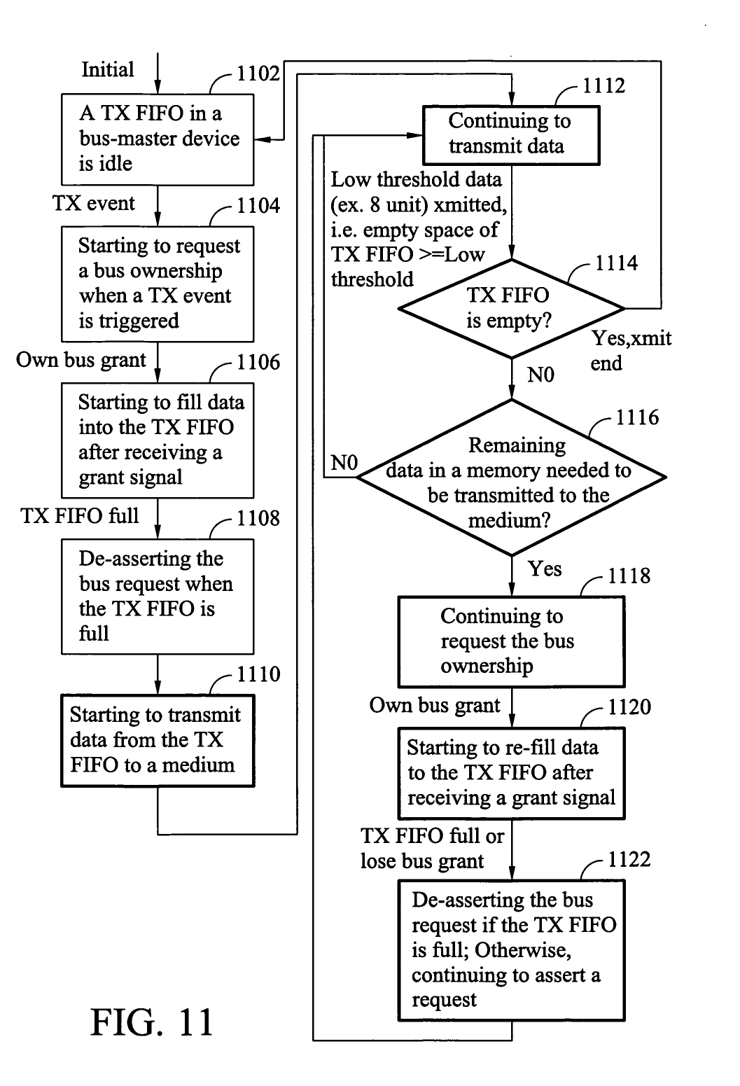

Please refer to FIG. 11. FIG. 11 is a flowchart of the TX FIFO operation method according to an embodiment of the invention. A detailed description is given in the following.

Step 1102: A TX FIFO in a bus-master device is idle.

Step 1104: Requesting bus ownership when a TX event is triggered.

Step 1106: Filling data into the TX FIFO after receiving a grant signal.

Step 1108: De-asserting the bus request when the TX FIFO is full.

Step 1110: Transmitting data from the TX FIFO to a medium.

Step 1112: Continuing to transmit data.

Step 1114: Determining whether the TX FIFO is empty. If yes, proceed to the step 1102; Otherwise, proceed to the step 1126.

Step 1116: Determining whether any data remaining in a memory needs to be transmitted to the medium. If yes, proceed to the step 1118; otherwise, proceed to step 1112.

Step 1118: Continuing to request bus ownership.

Step 1120: Starting to re-fill data to the TX FIFO after receiving a grant signal.

Step 1122: De-asserting the bus request if the TX FIFO is full; Otherwise, continuing to assert a request.

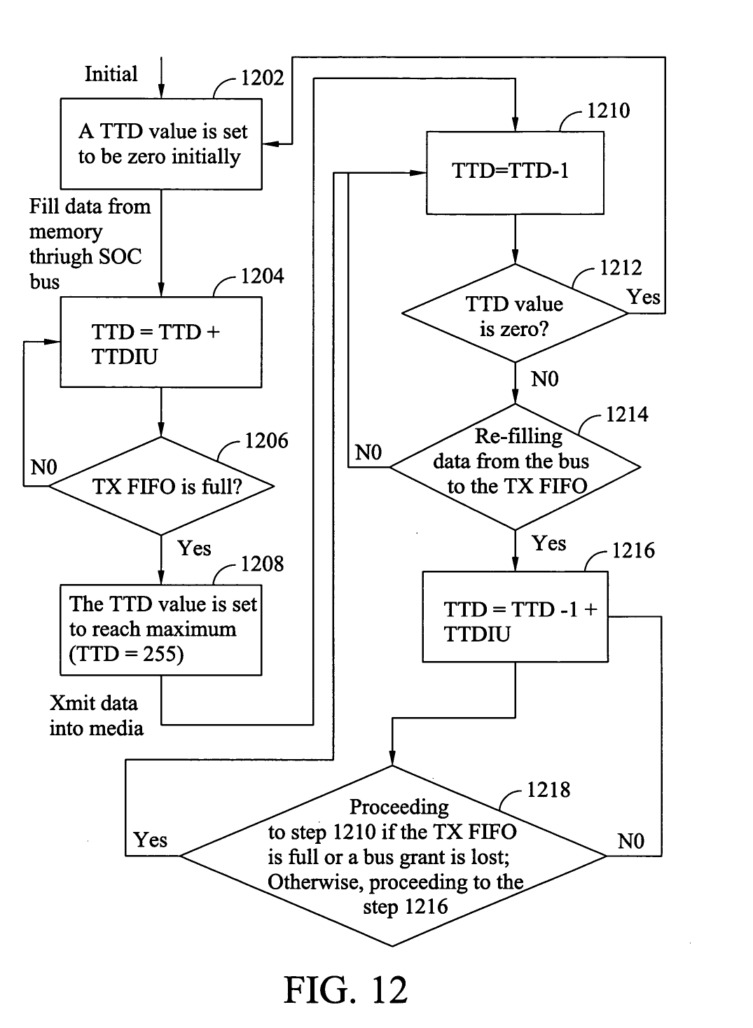

Please refer to FIG. 12. FIG. 12 is a flowchart of the TTD variation of TX operation method according to an embodiment of the invention. The label TTDIU represents an increased unit of TTD value. Assume that the maximum TTD value is 255. The TX FIFO output rate is equal to one data unit per clock cycle time and the TX FIFO input rate is equal to ten data unit per clock cycle time. In other words, the TTD value is decreased by one unit when data is transmitted to a medium and the TTD value is increased by ten unit when data is received from the bus (TTDIU=10). A detailed description is given in the following.

Step 1202: A TTD value is set to be zero initially.

Step 1204: The TTD value is added by a unit TTDIU (TTD=TTD+TTDIU).

Step 1206: Determining whether the TX FIFO is full. If yes, proceed to the step 1208; otherwise, to step 1204.

Step 1208: The TTD value is set to reach maximum (TTD=255).

Step 1210: Transmitting data to the medium while the TTD value is continuously decreased (TTD=TTD−1).

Step 1212: Determining whether the TTD value is zero. If yes, proceed to the step 1202; otherwise, to step 1214.

Step 1214: Re-filling data from the bus to the TX FIFO.

Step 1216: The TTD value is reset (TTD=TTD−1+TTDIU).

Step 1218: Proceeding to step 1210 if the TX FIFO is full or a bus grant is lost; otherwise, to step 1216.

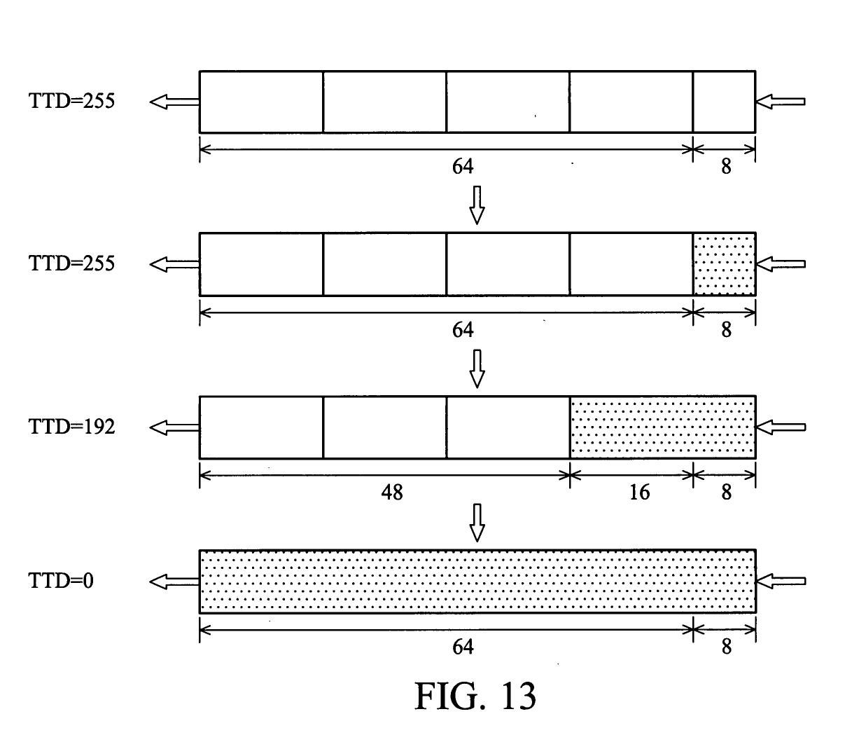

Please refer to FIG. 13. FIG. 13 shows the relationship between the received buffer size (e.g. RX FIFO) and the TTD value. Assume the FIFO volume and the largest TTD value are 64 (bytes) and 255. Additionally, the length of a threshold segment is set to be 8 (bytes). In the first allocation, the threshold segment and the TX FIFO are both empty. Please note that, after data in the threshold segment is received from medium (the threshold segment is full), the corresponding bus-master device will be allowed to send its request to receive data in the RX FIFO. When data in the RX FIFO is transmitted to bus, the TTD value is increased relatively. When data is re-filled in the RX FIFO, the TTD value is decreased relatively. In the second allocation, the threshold segment is full (8 bytes data inside) while the RX FIFO is empty and start to receive data from medium, then the TTD value reaches maximum (255). In the third allocation, the RX FIFO is filled and the length of empty part is 48 (bytes), then the TTD value changes to be 192. In the fourth allocation, the RX FIFO is filled to be full, then the TTD value changes to be zero. The TTD value is calculated according to the following formula:
TTD−RX=DS/DA

Wherein TTD−RX is the TTD value in the RX FIFO, DS is the data spare space in the RX FIFO, and DA is the data arrival (input) rate to medium. The data arrival rate is a predetermined value. In FIG. 13, assume that the data consumption rate is equal to 0.25. It shows that the data spare space is 64 (bytes) in the second allocation, 48 (bytes) in the third allocation, and 0 (bytes) in the fourth allocation. Through the above formula, the TTD values in each allocation can be calculated to be 255 (64/0.25) in the second allocation, 192 (48/0.25) in the third allocation, and 0 (0/0.25) in the fourth allocation.

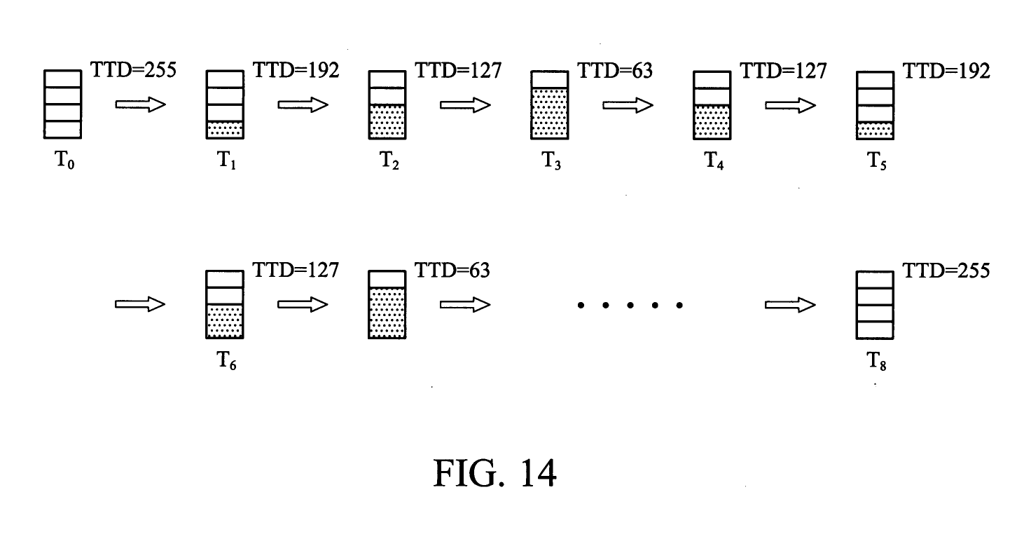

Please refer to FIG. 14. FIG. 14 shows the variation relationship between the TTD value and the RX FIFO. Assume that the maximum TTD value is 255. The TTD value is proportional to the current volume of the TX FIFO. If the TX FIFO is empty, then the TTD value will reach maximal. If the TX FIFO is full, the TTD value will reach minimum. Additionally, the arbiter selects one device with a minimum TTD value as a current device to transmit data through the bus. At time TO, the RX FIFO is empty, thus the TTD value reaches maximum (TTD value=255). At time T1, data is received from a medium (e.g. air) to fill the RX FIFO, thus the TTD value is decreased (TTD value=192). In the duration T1˜T3, the RX FIFO does not have the authority to utilize the bus and hence it can only receive data from the medium. Additionally, a request signal for authorization to again utilize the bus 540 is sent in the duration T1˜T3. In duration T4˜T5, the RX FIFO is again authorized and partial data can be received from the medium and other partial data can transmitted to the bus at the same time. At time T6, the RX FIFO again loses its authority and only receives data from the medium. Hence the TTD value decreases again. After a long time, the receiving task is finished at time T8 (RX FIFO is empty) and the TTD value is reset to zero.

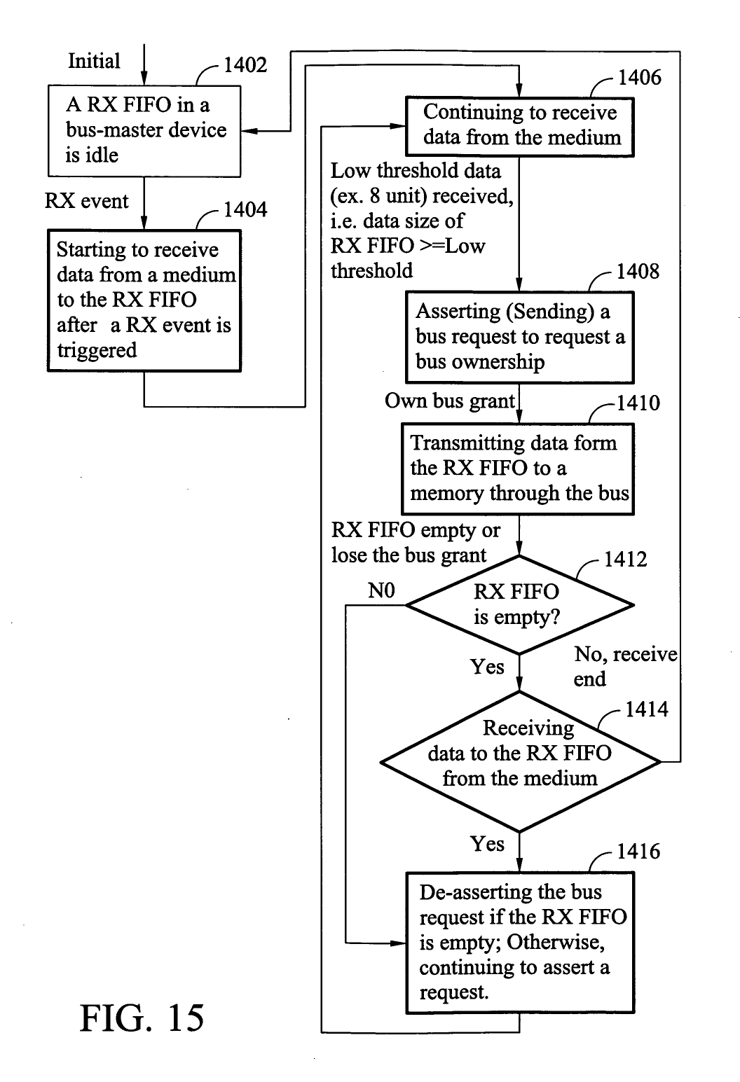

Please refer to FIG. 15. FIG. 15 is a flowchart of the RX FIFO operation method according to an embodiment of the invention. A detailed description is given in the following.

Step 1402: A RX FIFO in a bus-master device is idle.

Step 1404: Starting to receive data from a medium to the RX FIFO after a RX event is triggered.

Step 1406: Continuing to receive data from the medium.

Step 1408: Asserting (Sending) a bus request to request a bus ownership.

Step 1410: Transmitting data form the RX FIFO to a memory through the bus.

Step 1412: Determining whether the RX FIFO is empty. If yes, proceed to the step 1414; otherwise, to step 1416.

Step 1414: Receiving data to the RX FIFO from the medium.

Step 1416: De-asserting the bus request if the RX FIFO is empty; otherwise, continuing to assert a request.

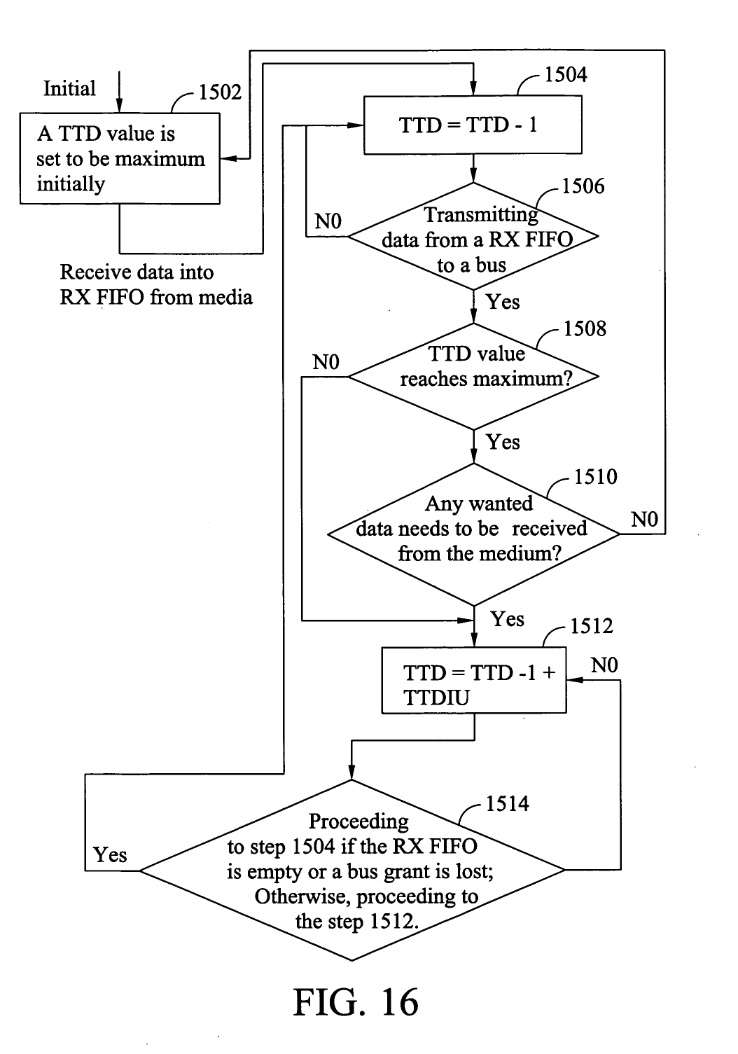

Please refer to FIG. 16. FIG. 16 is a flowchart of the TTD variation of RX operation method according to an embodiment of the invention. The label TTDIU means an increasing unit of TTD value. Assume that the maximum TTD value is 255, the RX FIFO input rate is equal to one data unit per clock cycle time and the RX FIFO output rate is equal to ten data unit per clock cycle time. In other words, the TTD value is decreased by one unit when data is received from the medium and the TTD value is increased by ten unit when data is transmitted to the bus (TTDIU=10). A detailed description is given in the following.

Step 1502: A TTD value is set to reach maximum (TTD=255) initially.

Step 1504: Receiving data from medium to a RX FIFO while the TTD value is continuously decreased (TTD=TTD−1).

Step 1506: Transmitting data from the RX FIFO to a bus.

Step 1508: Determining whether the TTD value was reached maximum. If yes, proceed to the step 1510; otherwise, to step 1512.

Step 1510: Determining whether any wanted data needs to be received from the medium. If yes, proceed to the step 1512; otherwise, to step 1502.

Step 1512: The TTD value is reset (TTD=TTD−1+TTDIU).

Step 1514: Proceeding to step 1504 if the RX FIFO is empty or a bus grant is lost; otherwise, to step 1512.

Compared with the first related arbitration, the arbitration method of the invention is much fairer since the priority of each bus-master device is not fixed. Compared with the second related arbitration, the arbitration method of the invention is more efficient to match the real requirement of each bus-master device by the help of TTD values.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An arbitration method applied in an embedded system communicating with other systems through a medium, said embedded system comprises a plurality of devices, a bus and an arbiter, each device comprises a buffer and a time-to-death (TTD) value, said arbiter chooses one device to access data through the bus according to the plurality of TTD values, comprising:
sending a plurality of request signals to the arbiter;
choosing one device to access data through the bus according to the plurality of TTD values, wherein the chosen device with a minimum TTD value is chosen;
increasing the TTD value of the chosen device when the chosen device is accessing data through the bus; and
choosing another device to access data through the bus when the TTD value of another device becomes minimum;
wherein each TTD value is utilized to record a current state of its corresponding buffer.

2. The arbitration method according to claim 1 further comprises: calculating the TTD value of each device.

3. The arbitration method according to claim 2, wherein the TTD value is calculated according to the formula:
TTD−TX=DR/DC
wherein each buffer in the embedded system is a transmitted buffer for receiving data from the bus and transmitting data to the medium, TTD−TX is the TTD value corresponding to the transmitted buffer, DR is a data residual in the transmitted buffer, and DC is the data consumption rate to the medium

4. The arbitration method according to claim 2, wherein the TTD value is calculated according to the formula:
TTD−RX=DS/DA
wherein each buffer in the embedded system is a received buffer for receiving data from the medium and transmitting data to the bus, TTD−RX is the TTD value corresponding to the received buffer, DS is the data spare space in the received buffer, and DC is the data arrival rate to the medium.

5. The arbitration method according to claim 1, wherein a mechanism of store and forward is utilized to access data.

6. The arbitration method according to claim 1, wherein a mechanism of cutting through is utilized to access data.

7. An embedded system communicating with other systems through a medium, said embedded system comprises a plurality of devices, a bus and an arbiter, each device comprises a buffer and a time-to-death (TTD) value, said arbiter chooses one device to access data through the bus according to the plurality of TTD values, comprising:
means for sending a plurality of request signals to the arbiter;
means for choosing one device to access data through the bus according to the plurality of TTD values, wherein the chosen device with a minimum TTD value is chosen;
means for increasing the TTD value of the chosen device when the chosen device is accessing data through the bus; and
means for choosing another device to access data through the bus when the TTD value of another device becomes minimum;
wherein each TTD value is utilized to record a current state of its corresponding buffer.

8. The arbitration method according to claim 7 further comprises:
means for calculating the TTD value of each device.

9. The arbitration method according to claim 8, wherein the TTD value is calculated according to the formula:
TTD−TX=DR/DC
wherein each buffer in the embedded system is a transmitted buffer for receiving data from the bus and transmitting data to the medium, TTD−TX is the TTD value corresponding to the transmitted buffer, DR is a data residual in the transmitted buffer, and DC is the data consumption rate to the medium.

10. The arbitration method according to claim 8, wherein the TTD value is calculated according to the formula:
TTD−RX=DS/DA
wherein each buffer in the embedded system is a received buffer for receiving data from the medium and transmitting data to the bus, TTD−RX is the TTD value corresponding to the received buffer, DS is the data spare space in the received buffer, and DC is the data arrival rate to the medium.

11. The arbitration method according to claim 5, wherein the bus is an AHB bus.
